(19) United States
(12) Patent Application Publication
(10) Pub. No.: US 2008/0143880 A1
(43) Pub. Date: Jun. 19, 2008

(54) METHOD AND APPARATUS FOR DETECTING CAPTION OF VIDEO

(75) Inventors: Cheol Kon Jung, Yongin-si (KR); Qifeng Liu, Yongin-si (KR); Ji Yeun Kim, Yongin-si (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/763,689

(22) Filed: Jun. 15, 2007

(30) Foreign Application Priority Data
Dec. 14, 2006 (KR) 10-2006-0127735

(51) Int. Cl. H04N 5/14

(52) U.S. Cl. 348/571; 348/E05.062

(57) ABSTRACT

A method of detecting a caption of a video, the method including: detecting a caption candidate area of a predetermined frame of an inputted video; verifying a caption area from the caption candidate area by performing a Support Vector Machine (SVM) scanning for the caption candidate area; detecting a text area from the caption area; and recognizing predetermined text information from the text area.

### CROSS-REFERENCE TO RELATED APPLICATION

This application claims the benefit of Korean Patent Application No. 10-2006-0127735, filed on Dec. 14, 2006, in the Korean Intellectual Property Office, the disclosure of which is incorporated herein by reference.

### BACKGROUND OF THE INVENTION

1. Field of the Invention

The present invention relates to a method and apparatus for detecting a caption of a video, and more particularly, to a method and apparatus for detecting a caption of a video which detect the caption more accurately and efficiently even when the caption is a semitransparent caption having a text area affected by a background area, and thereby may be effectively used in a video summarization and search service.

2. Description of Related Art

Many types of captions, intentionally inserted by content providers, are included in videos. However, captions which are used for a video summarization and search are just a few of the many types of captions. The captions used for video summarization are called a key caption. Such key captions are required to be detected in videos for video summarization and search, and making video highlights.

For example, key captions included in videos may be used to easily and rapidly play and edit articles of a particular subject in news articles and main scenes in sporting events such as a baseball. Also, a customized broadcasting service may be embodied in a personal video recorder (PVR), a Wibro terminal, a digital multimedia broadcasting (DMB) phone, and the like, by using captions detected in videos.

Generally, in a method of detecting a caption of a video, an area, which shows a superimposition during a predetermined period of time, is determined and caption contents are detected from the area. For example, an area where the superimposition of captions is dominant for thirty seconds is used to determine captions. The same operation is repeated for a subsequent thirty seconds, areas where the superimposition is dominant are accumulated for a predetermined period of time, and thus a target caption is selected.

However, in a conventional art described above, a superimposition of target captions is detected in a local time area, which reduces a reliability of the caption detection. As an example, although target captions such as anchor titles of news or scoreboards of sporting events are required to be detected, other captions which are similar to the target captions, e.g. a logo of a broadcasting station or a commercial, may be detected as the target captions. Accordingly, key captions such as scores of sporting events are not detected, and thereby may reduce a reliability of services.

Also, when locations of target captions are changed over time, the target captions may not be detected in the conventional art. As an example, locations of captions are not fixed in a right/left or a top/bottom position and changed in real-time in sports videos such as golf. Accordingly, the target captions may not be detected by only time-based superimposition of captions.

Also, in sports video, a method of determining a player name caption area by extracting dominant color descriptors (DCDs) of caption areas and performing a clustering exists. In this instance, the DCDs of caption areas are detected with an assumption that color patterns of player name captions are regular. However, when the player name caption areas are semitransparent caption areas, color patterns are not regular throughout a corresponding sports video. Specifically, when the player name caption areas are semitransparent caption areas, the player name caption areas are affected by colors of background areas, and thus the color patterns with respect to a same caption may be differently set. Accordingly, when the player name caption areas are semitransparent caption areas, the player name caption detection performance may be degraded.

Accordingly, a method and apparatus for detecting a caption of a video which detect the caption more accurately and efficiently even when the caption is a semitransparent caption having a text area affected by a background area, and thereby may be effectively used in a video summarization and search service, is needed.

### BRIEF SUMMARY

Accordingly, it is an aspect of the present invention to provide a method and apparatus for detecting a caption of a video which use a recognition result of a caption text in the video as a feature, and thereby may detect the caption as well as a semitransparent caption, affected by a background area, more accurately.

It is another aspect of the present invention to provide a method and apparatus for detecting a caption of a video which reduce a number of caption areas to be recognized by a caption area verification, and thereby may improve a processing speed.

It is another aspect of the present invention to provide a method and apparatus for detecting a caption of a video including a text recognition module which may accurately detect a caption, which is not recognized by a horizontal projection, by recognizing text information from a verified caption area by using a connected component analysis (CCA).

According to an aspect of the present invention, there is provided a method of detecting a caption of a video, the method including: detecting a caption candidate area of a predetermined frame of an inputted video; verifying a caption area from the caption candidate area by performing a Support Vector Machine (SVM) scanning for the caption candidate area; detecting a text area from the caption area; and recognizing predetermined text information from the text area.

According to an aspect of the present invention, there is provided a method of detecting a caption of a video, the method including: generating a line unit text area by collecting texts connected to each other, from other texts included in the text area, in a single area, about a text area which is detected from a predetermined video caption area; and recognizing predetermined text information by interpreting the line unit text area.

According to aspect of the present invention, there is provided an apparatus for detecting a caption of a video, the apparatus including: a caption candidate detection module detecting a caption candidate area of a predetermined frame of an inputted video; a caption verification module verifying a caption area from the caption candidate area by performing a SVM determination for the caption candidate area; a text detection module detecting a text area from the caption area; and a text recognition module recognizing predetermined text information from the text area.

According to another aspect of the present invention, there is provided a text recognition module, the text recognition module including: a line unit text generation unit generating a line unit text area by collecting texts connected to each other, from other texts included in the text area, in a single area, about a text area which is detected from a predetermined video caption area; and a text information recognition unit recognizing predetermined text information by interpreting the line unit text area.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a diagram illustrating a configuration of an apparatus for detecting a caption of a video, according to an embodiment of the present invention;

FIG. 2 is a diagram illustrating an example of detecting a caption of a video, according to an embodiment of the present invention;

FIG. 3 is a diagram illustrating a caption candidate detection screen of a video, according to an embodiment of the present invention;

FIGS. 4A through 4C are diagrams illustrating an operation of detecting a caption from a detected caption candidate area, according to an embodiment of the present invention;

FIG. 5 is a diagram illustrating a double binarization method, according to an embodiment of the present invention;

FIG. 6 is a diagram illustrating an example of a double binarization method of FIG. 5;

FIG. 7 is a block diagram illustrating a configuration of a text recognition module, according to an embodiment of the present invention;

FIGS. 8A through 8C are diagrams illustrating an operation of recognizing a text, according to an embodiment of the present invention;

FIG. 9 is a flowchart illustrating a method of detecting a caption of a video, according to an embodiment of the present invention;

FIG. 10 is a flowchart illustrating a method of detecting a caption candidate area, according to an embodiment of the present invention;

FIG. 11 is a flowchart illustrating a method of verifying a caption area, according to an embodiment of the present invention;

FIG. 12 is a flowchart illustrating a method of detecting a text area by a double binarization, according to an embodiment of the present invention; and

FIG. 13 is a flowchart illustrating a method of recognizing text information, according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

A method and apparatus for detecting a caption of a video according to an embodiment of the present invention may be embodied in all video services which are required to detect a caption. Specifically, the method and apparatus for detecting a caption of a video may be embodied in all videos, regardless of a genre of the video. However, in this specification, it is described that the method and apparatus for detecting a caption of a video detect a player name caption of a sports video, specifically, a golf video, as an example. Although a player name caption detection of the golf video is described as an example, the method and apparatus for detecting a caption of a video according to an embodiment of the present invention may be embodied to be able to detect many types of captions in all videos.

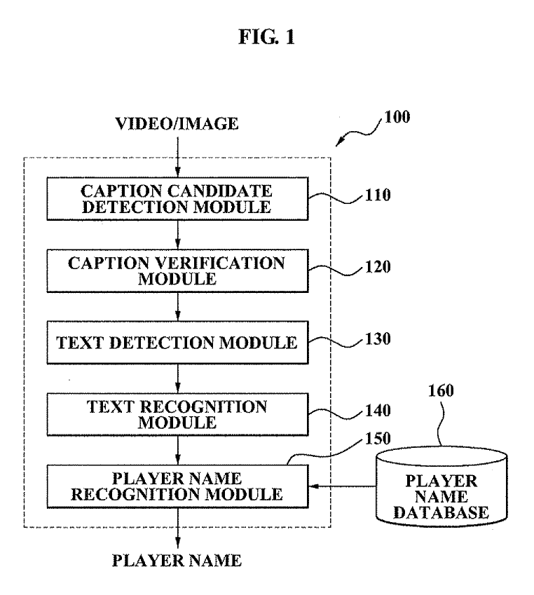

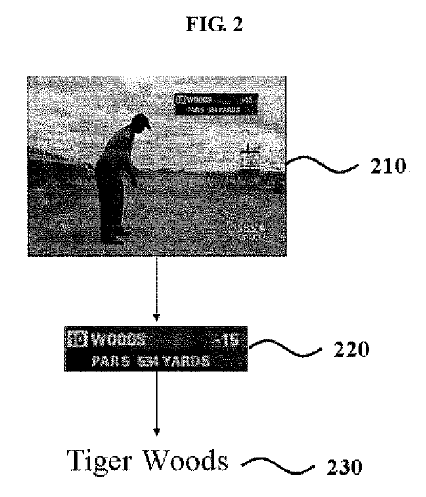

FIG. 1 is a diagram illustrating a configuration of an apparatus for detecting a caption of a video, according to an embodiment of the present invention, and FIG. 2 is a diagram illustrating an example of detecting a caption of a video according to an embodiment of the present invention.

The apparatus for detecting a caption of a video 100 includes a caption candidate detection module 110, a caption verification module 120, a text detection module 130, a text recognition module 140, a player name recognition module 150, and a player name database 160.

As described above, in this specification, it is described that the apparatus for detecting a caption of a video 100 recognizes a player name caption in a golf video of sports videos. Accordingly, the player name recognition module 150 and the player name database 160 are components depending on the embodiment of the present invention, as opposed to essential components of the apparatus for detecting a caption of a video 100.

According to the present invention, the object of the present invention is that a caption area 220 is detected from a sports video 210, and a player name 230, i.e. text information included in the caption area 220, is recognized, as illustrated in FIG. 2. Hereinafter, a configuration and an operation of the apparatus for detecting a caption of a video 100 in association with a player name recognition from such a sports video caption will now be described in detail.

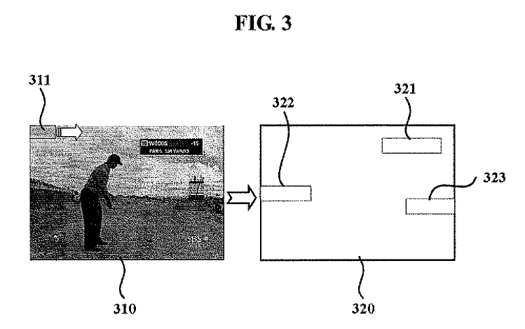

FIG. 3 is a diagram illustrating a caption candidate detection screen of a video, according to an embodiment of the present invention.

A caption candidate detection module 110 detects a caption candidate area of a predetermined frame 310 of an inputted video. The inputted video is obtained from a stream of a golf video, i.e. a sports video, and may be embodied as a whole or a portion of the golf video. Also, when the golf video is segmented by a scene unit, the inputted video may be embodied as a representative video which is detected for each scene.

The caption candidate detection module 110 may rapidly detect the caption candidate area by using edge information of a text included in the frame 310. For this, the caption candidate detection module 110 may include a sobel edge detector. The caption candidate detection module 110 constructs an edge map from the frame 310 by using the sobel edge detector. An operation of constructing the edge map using the sobel edge detector may be embodied in a method well-known in related arts, and thus the operation of constructing is omitted for clarity and conciseness.

The caption candidate detection module 110 detects an area having many edges by scanning the edge map to a window 310 with a predetermined size. Specifically, the caption candidate detection module 110 may sweep the window 310 with the predetermined size, e.g. 8×16 pixels, and scan a caption area. The caption candidate detection module 110 may detect the area having many edges, i.e. an area having a great difference from a periphery, while scanning the window.

The caption candidate detection module 110 detects the caption candidate area by performing a connected component analysis (CCA) of the detected area. The CCA may be embodied as a CCA method which is widely used in related arts, and thus a description of the CCA is omitted for clarity and conciseness.

Specifically, as illustrated in FIG. 3, the caption candidate detection module 110 may detect caption candidate areas 321, 322, and 323 through operations of constructing the edge map, the window scanning, and the CCA via the sobel edge detector.

However, the detected caption candidate area is detected by edge information. Accordingly, due to a window size, the detected caption candidate area may include an area which is not an actual caption area, and is a background area excluding a text area. Accordingly, the detected caption candidate area may be detected by a caption verification module 120.

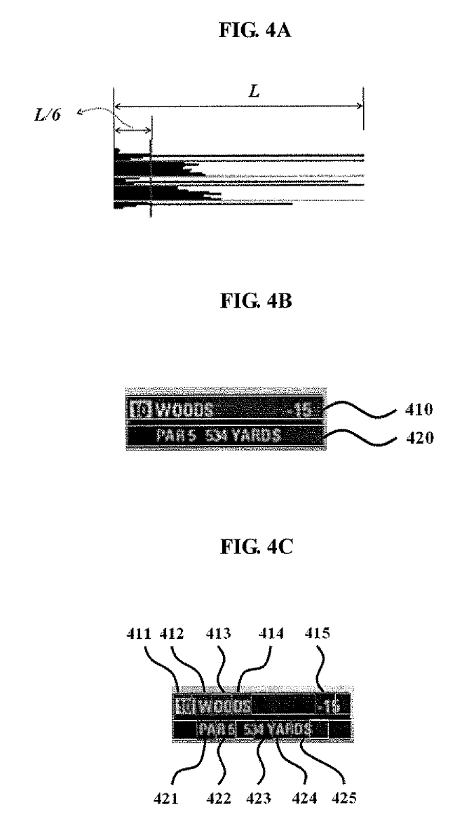

The caption verification module 120 verifies the caption candidate area is the caption area by performing a Support Vector Machine (SVM) scanning for the detected caption candidate area. An operation of caption verification module 120 is described in detail with reference to FIGS. 4A through 4C.

FIGS. 4A through 4C are diagrams illustrating an operation of detecting a caption from a detected caption candidate area, according to an embodiment of the present invention.

A caption verification module 120 determines a verification area by horizontally projecting an edge value of a detected caption candidate area. Specifically, as illustrated in FIG. 4A, the caption verification module 120 may determine the verification area by projecting the edge value of the detected caption candidate area. In this instance, when a maximum value of a number of the horizontally projected pixels is L, a threshold value may be set as L/6.

The caption verification module 120 performs a SVM scanning of the verification area. The caption verification module 120 may perform the SVM scanning of an area with a high edge density of the verification area through a window having a predetermined pixel size. The area with the high edge density may be set as a first verification area 410 and a second verification area 420, as illustrated in FIG. 4B. In this instance, a text is stored in the first verification area 410 and the second verification area 420 of the verification area.

The caption verification module 120 performs the SVM scanning of the first verification area 410 and the second verification area 420 through the window having the predetermined pixel size. As an example, the caption verification module 120 normalizes a height of the first verification area 410 and the second verification area 420 as 15 pixels, scans a window having a 15×15 pixel size, and performs a determination of a SVM classifier. When performing the SVM scanning, a gray value may be used as an input feature.

As a result of determination, when a number of accepted windows is greater than or equal to a predetermined value, e.g. 5, the caption verification module 120 verifies the caption candidate area as a text area. As an example, as illustrated in FIG. 4C, as a result of the determination by the SVM classifier through the window scanning of the first verification area 410, when the number of accepted windows is determined to be five, (i.e. accepted windows 411, 412, 413, 414, and 415), the caption verification module 120 may verify the first verification area 410 as the text area.

Also, as a result of the determination by the SVM classifier through the window scanning of the second verification area 420, when the number of accepted windows is determined to be five, (i.e. accepted windows 421, 422, 423, 424, and 425), the caption verification module 120 may verify the second verification area 420 as the text area.

As described above, the apparatus for detecting a caption of a video according to an embodiment of the present invention verifies the caption candidate area is the caption area through the caption verification module 120. Accordingly, an operation of recognizing a text from a caption candidate area including a non-caption area is previously prevented, and thereby may reduce a processing time required for a recognition of the text area.

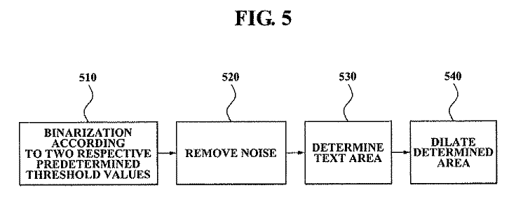

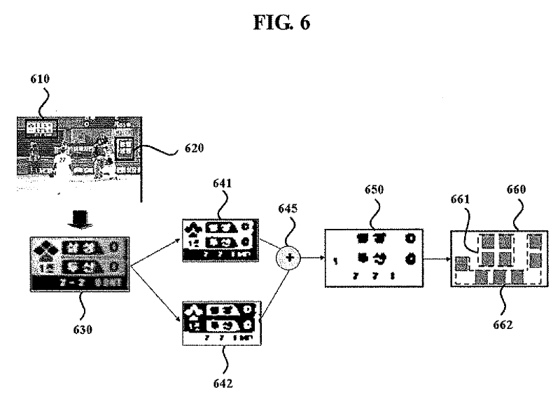

The text detection module 130 detects the text area from the caption area by using a double binarization. Specifically, the text detection module 130 generates two binarized videos of the caption area by binarizing the caption area as a gray opposite to each other, according to two respective predetermined threshold values, removes a noise of the two binarized videos according to a predetermined algorithm. Also, the text detection module 130 determines predetermined areas by synthesizing two videos where the noise is removed, and detects the text area by dilating the determined areas to a predetermined size. The double binarization is described in detail with reference to FIGS. 5 and 6.

FIG. 5 is a diagram illustrating a double binarization method, according to an embodiment of the present invention, and FIG. 6 is a diagram illustrating an example of a double binarization method of FIG. 5.

As described above, a text detection module 130 may detect a text area from a caption area 630 by using the double binarization. The double binarization is a method to easily detect the text area having a gray opposite to each other. As illustrated in FIG. 5, in operation 510, a binarization of the caption area 630 according to two threshold values, e.g. a first threshold value TH1 and a second threshold value TH2, is performed. In this instance, the first threshold value TH1 and the second threshold value TH2 may be determined by an Otsu method, and the like. The caption area 630 may be binarized as two images 641 and 642, respectively, as illustrated in FIG. 6. As an example, when a gray of each pixel is greater than the first threshold value TH1, the caption area 630 is converted as to a gray 0. When the gray of each pixel is equal to or less than the first threshold value TH1, the caption area 630 is converted as a maximum gray, e.g. gray 255 in a case of 8-bit data, and thereby may obtain 641 images.

Also, when the gray of each pixel is less than the second threshold value TH2, the caption area 630 is converted as the gray 0. When the gray of each pixel is equal to or greater than the second threshold value TH2, the caption area 630 is converted as the maximum gray, and thereby may obtain 642 images.

As described above, after the binarization of the caption area 630, a noise is removed according to a predetermined interpolation or an algorithm in operation 520. In operation 530, the binarized videos 641 and 642 are synthesized 645, and an area 650 is determined. In operation 540, the determined area is dilated to a predetermined size, and a desired text area 660 may be detected.

As described above, the apparatus for detecting a caption of a video 100 detects the text area from the caption area through the text detection module 130 by using the double binarization. Accordingly, color polarities of texts are different the text area may be effectively detected.

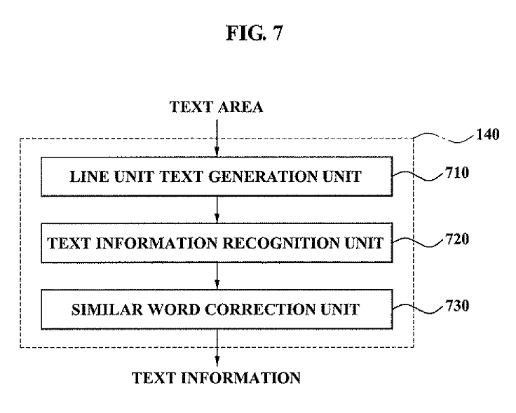

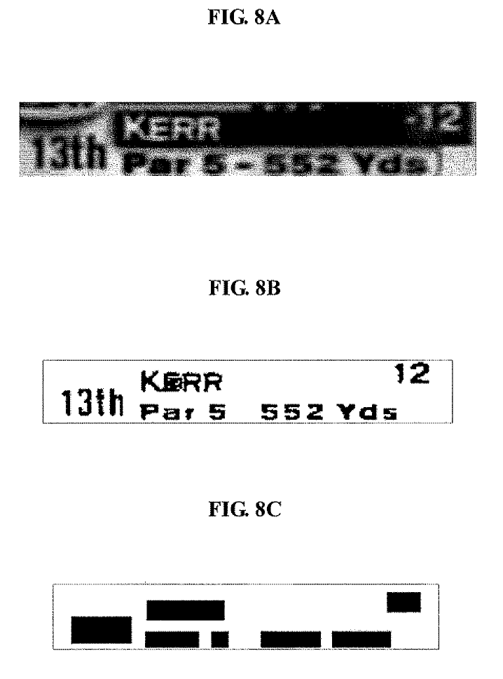

A text recognition module 140 recognizes predetermined text information from the text area, which is described in detail with reference to FIGS. 7 and 8.

FIG. 7 is a block diagram illustrating a configuration of a text recognition module, according to an embodiment of the present invention.

FIG. 8 is a diagram illustrating an operation of recognizing a text, according to an embodiment of the present invention.

A text recognition module 140 according to an embodiment of the present invention includes a line unit text generation unit 710, a text information recognition unit 720, and a similar word correction unit 730.

The line unit text generation unit 710 generates a line unit text area by collecting texts connected to each other, from other texts included in a text area, in a single area. Specifically the line unit text generation unit 710 may reconstruct the text area as the line unit text area in order to interpret the text area via optical character recognition (OCR).

The line unit text generation unit 710 connects an identical string by performing a dilation of a segmented text area. Then, the line unit text generation unit 710 may generate the line unit text area by collecting the connected texts in the single area.

As an example, as illustrated in FIGS. 8A and 8B, the line unit text generation unit 710 connects the identical string of each text included in the text area, and thereby may obtain the identical string such as ‘13^{th}’, ‘KERR’, ‘Par 5’, and ‘552 Yds’. Also, the line unit text generation unit 710 may generate the line unit text area by performing a CCA of the identical string connected to each other as illustrated in FIG. 8C.

As described above, the line unit text generation unit 710 generates the line unit text area by the CCA, as opposed to by horizontally projecting in a conventional art. Accordingly, text information may be accurately recognized from a text area which is not generated by a horizontal projection method like FIG. 8A. The CCA may be embodied as a CCA method which is widely used in related arts, and thus a description of the CCA is omitted for clarity and conciseness.

The text information recognition unit 720 recognizes predetermined text information by interpreting the line unit text area. The text information recognition unit 720 may interpret the line unit text area by OCR. Accordingly, the text information recognition unit 720 may include the OCR. The interpretation of the line unit text area by using the OCR may be embodied as an optical character interpretation method which is widely used in related arts, and thus a description of the interpretation is omitted.

The similar word correction unit 730 corrects a similar word of the recognized text information. As an example, the similar word correction unit 730 may correct a digit ‘0’ as a text ‘o’, and may correct a digit ‘9’ as a text ‘g’. As an example, when a text to be recognized is ‘Tiger Woods’, a result of the text recognition by the text information recognition unit 720 through the OCR may be ‘Tiger Wo0ds’. In this instance, the similar word correction unit 730 corrects the digit ‘0’ as the text ‘o’, and thereby may recognize the text more accurately.

The player name database 160 maintains player name information of at least one sport. The player name database 160 may store the player name information by receiving the player name information from a predetermined external server via a predetermined communication module. As an example, the player name database 160 may receive the player name information by connecting a server of an association of each sports, e.g. FIFA, PGA, LPGA, and MLB, a server of a broadcasting station, or an electronic program guide (EPG) server. Also, the player name database 160 may store player name information which is interpreted from a sports video. For example, the player name database 160 may interpret and store the player name information through a caption of a leader board of the sports video.

The player name recognition module 150 extracts, from the player name database 160, a player name having a greatest similarity to the recognized text information. The player name recognition module 150 may extract the player name having the greatest similarity to the recognized text information through a string matching by a word unit, from the player name database 160. The player name recognition module 150 may perform the string matching by the word unit in a full name matching and a family name matching order. The full name matching may be embodied as a full name matching of two or three words, e.g. Tiger Woods, and the family name matching may be embodied as a family name matching of a single word, e.g. Woods.

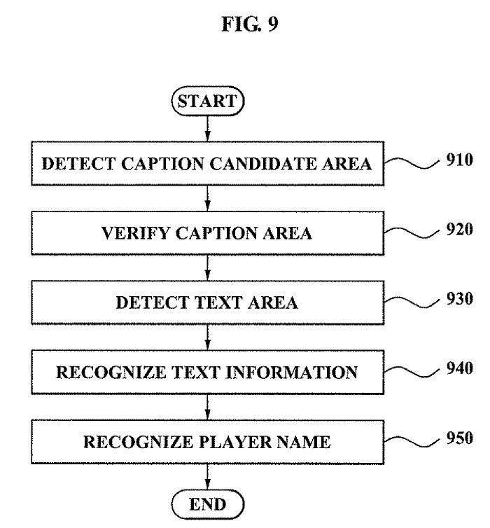

A configuration and an operation of the apparatus for detecting a caption of a video according to an embodiment of the present invention have been described with reference to FIGS. 1 through 8. Hereinafter, a method of detecting a caption of a video according to the apparatus for detecting a caption of a video is described with reference to FIGS. 9 through 13.

FIG. 9 is a flowchart illustrating a method of detecting a caption of a video, according to an embodiment of the present invention.

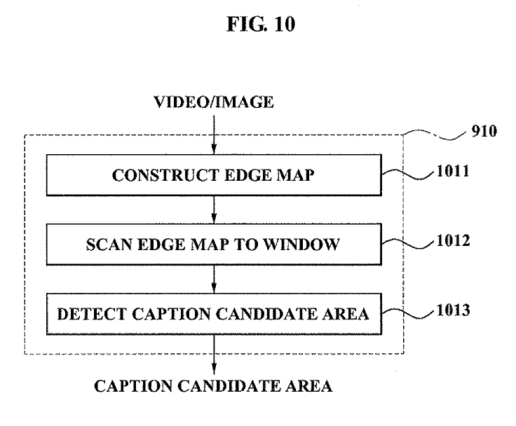

In operation 910, an apparatus for detecting a caption of a video detects a caption candidate area of a predetermined frame of an inputted video. The inputted video may be embodied as a sports video. Operation 910 is described in detail with reference to FIG. 10.

FIG. 10 is a flowchart illustrating a method of detecting a caption candidate area, according to an embodiment of the present invention.

In operation 1011, an apparatus for detecting a caption of a video constructs an edge map by performing a sobel edge detection for the frame. In operation 1012, the apparatus for detecting a caption of a video detects an area having many edges by scanning the edge map to a window with a predetermined size. In operation 1013, the apparatus for detecting a caption of a video detects the caption candidate area by performing a CCA of the detected area.

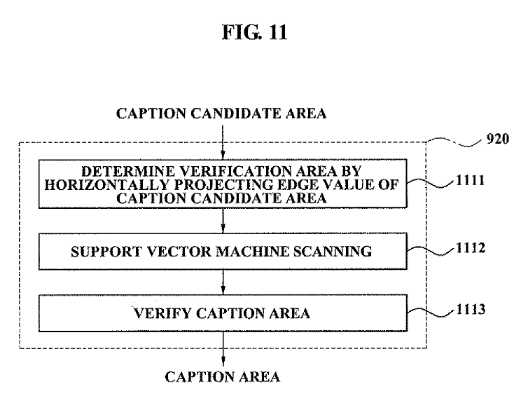

Referring again to FIG. 9, the apparatus for detecting a caption of a video verifies a caption area from the caption candidate area by performing a SVM scanning for the caption candidate area in operation 920. Operation 920 is described in detail with reference to FIG. 11.

FIG. 11 is a flowchart illustrating a method of verifying a caption area, according to an embodiment of the present invention.

In operation 1111, the apparatus for detecting a caption of a video determines a verification area by horizontally projecting an edge value of the caption candidate area. In operation 1112, the apparatus for detecting a caption of a video performs the SVM scanning of an area with a high edge density of the verification area through a window having a predetermined pixel size. In operation 1113, the apparatus for detecting a caption of a video verifies the caption candidate area as the text area, when a number of accepted windows is greater than or equal to a predetermined value, as a result of the scanning.

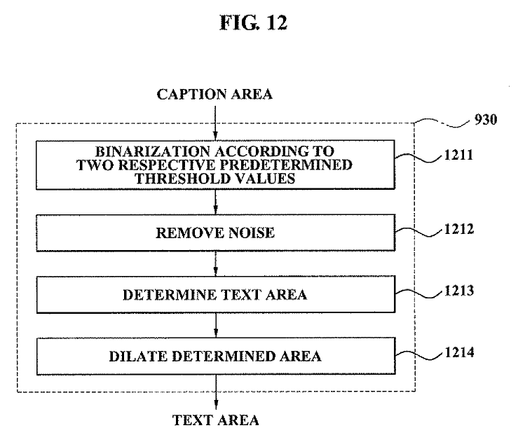

Referring again to FIG. 9, the apparatus for detecting a caption of a video detects the text area from the caption area in operation 930. The apparatus for detecting a caption of a video may detect the text area from the caption area by using a double binarization, which is described in detail with reference to FIG. 12.

FIG. 12 is a flowchart illustrating a method of detecting a text area by a double binarization, according to an embodiment of the present invention.

In operation 1211, the apparatus for detecting a caption of a video generates two binarized videos of the caption area by binarizing the caption area as a gray opposite to each other, according to two respective predetermined threshold values. In operation 1212, the apparatus for detecting a caption of a video removes a noise of the two binarized videos according to a predetermined algorithm. In operation 1213, the apparatus for detecting a caption of a video determines predetermined areas by synthesizing two videos where the noise is removed. In operation 1214, the apparatus for detecting a caption of a video detects the text area by dilating the determined areas to a predetermined size.

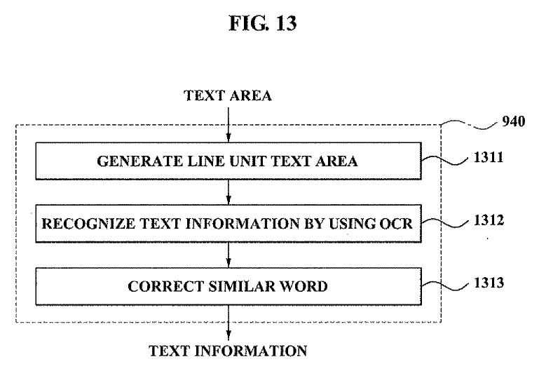

Referring again to FIG. 9, the apparatus for detecting a caption of a video recognizes predetermined text information from the text area in operation 940, which is described in detail with reference to FIG. 13.

FIG. 13 is a flowchart illustrating a method of recognizing text information, according to an embodiment of the present invention.

In operation 1311, the apparatus for detecting a caption of a video generates a line unit text area by collecting texts connected to each other, from other texts included in the text area, in a single area. The apparatus for detecting a caption of a video may generate the line unit text area by performing a CCA of the single area where the texts connected to each other are collected.

In operation 1312, the apparatus for detecting a caption of a video recognizes predetermined text information by interpreting the line unit text area through OCR. In operation 1313, the apparatus for detecting a caption of a video corrects a similar word of the recognized text information.

Referring again to FIG. 9, the apparatus for detecting a caption of a video maintains a player name database which maintains player name information of at least one sport. The apparatus for detecting a caption of a video may store the player name information in the player name database by receiving predetermined player name information from a predetermined external server. Also, the apparatus for detecting a caption of a video may interpret the player name information from a player name caption included in the sports video, and store the player name information in the player name database.

The apparatus for detecting a caption of a video extracts, from the player name database, a player name having a greatest similarity to the recognized text information. In this instance, the similarity is measured by a string matching by a word unit, and the string matching by the word unit is performed in a full name matching and a family name matching order. In operation 950, the apparatus for detecting a caption of a video may recognize the player name from the text information.

Although it is simply described, the method of detecting a caption of a video according to an embodiment of the present invention, which has been described with reference to FIGS. 9 through 13, may be embodied to include a configuration and an operation of the apparatus for detecting a caption of a video according to an embodiment of the present invention.

The method of detecting a caption of a video according to the above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

A method and apparatus for detecting a caption of a video according to the above-described embodiments of the present invention use a recognition result of a caption text in the video as a feature, and thereby may detect the caption as well as a semitransparent caption, affected by a background area, more accurately.

Also, a method and apparatus for detecting a caption of a video according to the above-described embodiments of the present invention reduce a number of caption areas to be recognized by a caption area verification, and thereby may improve a processing speed.

Also, a method and apparatus for detecting a caption of a video including a text recognition module according to the above-described embodiments of the present invention may accurately detect a caption, which is not recognized by a horizontal projection, by recognizing text information from a verified caption area by using a CCA.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of detecting a caption of a video, the method comprising:
detecting a caption candidate area of a predetermined frame of an inputted video;
verifying a caption area from the caption candidate area by performing a Support Vector Machine (SVM) scanning for the caption candidate area;
detecting a text area from the caption area; and
recognizing predetermined text information from the text area.

2. The method of claim 1, wherein the inputted video is a sports video.

3. The method of claim 1, wherein the detecting of the caption candidate area comprises:
constructing an edge map by performing a sobel edge detection for the frame;
detecting an area having many edges by scanning the edge map to a window with a predetermined size; and
detecting the caption candidate area by performing a connected component analysis (CCA) of the detected area.

4. The method of claim 1, wherein the verifying and performing comprises:
determining a verification area by horizontally projecting an edge value of the caption candidate area;
performing a SVM scanning of an area with a high edge density of the verification area through a window having a predetermined pixel size;
verifying the caption candidate area as the text area, when a number of accepted windows is greater than or equal to a predetermined value, as a result of the scanning.

5. The method of claim 1, wherein the detecting of the text area detects the text area from the caption area by using a double binarization.

6. The method of claim 5, wherein the double binarization comprises:
generating two binarized videos of the caption area by binarizing the caption area into a gray scale contrasting each other, according to two respective predetermined threshold values;
removing a noise of the two binarized videos according to a predetermined algorithm;
determining predetermined areas by synthesizing two videos where the noise is removed; and
detecting the text area by dilating the determined areas to a predetermined size.

7. The method of claim 1, wherein the recognizing comprises:
generating a line unit text area by collecting texts connected to each other, from other texts included in the text area, in a single area;
recognizing predetermined text information by interpreting the line unit text area by optical character recognition (OCR); and
correcting a similar word of the recognized text information.

8. The method of claim 7, wherein the generating comprises:
generating the line unit text area by performing a CCA of the single area where the texts connected to each other are collected.

9. The method of claim 2, further comprising:
maintaining a player name database which maintains player name information of at least one sport; and
extracting, from the player name database, a player name having a greatest similarity to the recognized text information.

10. The method of claim 9, wherein the similarity is measured by a string matching by a word unit, and the string matching by the word unit is performed in a full name matching and a family name matching order.

11. The method of claim 9, wherein the maintaining comprises:
storing the player name information in the player name database by receiving predetermined player name information from a predetermined external server; and
interpreting the player name information from a player name caption included in the sports video, and storing the player name information in the player name database.

12. A method of detecting a caption of a video, the method comprising:
generating a line unit text area by collecting texts connected to each other, from other texts included in the text area, in a single area, about a text area which is detected from a predetermined video caption area; and
recognizing predetermined text information by interpreting the line unit text area.

13. The method of claim 12, wherein the generating comprises:
generating the line unit text area by performing a CCA of the single area where the texts connected to each other are collected.

14. The method of claim 12, wherein the line unit text area is interpreted by OCR.

15. The method of claim 12, further comprising:
correcting a similar word of the recognized text information.

16. A computer-readable recording medium storing a program for implementing a method of detecting a caption of a video, the method comprising:
detecting a caption candidate area of a predetermined frame of an inputted video;
verifying a caption area from the caption candidate area by performing an SVM scanning for the caption candidate area;
detecting a text area from the caption area; and
recognizing predetermined text information from the text area.

17. An apparatus for detecting a caption of a video, the apparatus comprising:
a caption candidate detection module detecting a caption candidate area of a predetermined frame of an inputted video;
a caption verification module verifying a caption area from the caption candidate area by performing a SVM determination for the caption candidate area;
a text detection module detecting a text area from the caption area; and
a text recognition module recognizing predetermined text information from the text area.

18. The apparatus of claim 17, wherein the inputted video is a sports video.

19. The apparatus of claim 17, wherein the caption candidate detection module comprises a sobel edge detector, constructs an edge map of the frame by the sobel edge detector, scans the edge map to a window with a predetermined size, generates an area having many edges, and detects the caption candidate area through a CCA.

20. The apparatus of claim 17, wherein the caption verification module determines a verification area by horizontally projecting an edge value of the caption candidate area, performs a SVM scanning of an area with a high edge density of the verification area through a window having a predetermined pixel size, and verifies the caption candidate area as a text area, when a number of accepted windows is greater than or equal to a predetermined value, as a result of the scanning.

21. The apparatus of claim 17, wherein the text detection module detects the text area from the caption area by using a double binarization.

22. The apparatus of claim 21, wherein the text detection module, generates two binarized videos of the caption area by binarizing the caption area as a gray opposite to each other, according to two respective predetermined threshold values, removes a noise of the two binarized videos according to a predetermined algorithm, determines predetermined areas by synthesizing to videos where the noise is removed, and detects the text area by dilating the determined areas to a predetermined size.

23. The apparatus of claim 17, wherein the text recognition module generates a line unit text area by collecting texts connected to each other, from other texts included in the text area, in a single area, recognizes predetermined text information by interpreting the line unit text area by OCR, and corrects a similar word of the recognized text information.

24. The apparatus of claim 23, wherein the text recognition module generates the line unit text area by performing a CCA of the single area where the texts connected to each other are collected.

25. The apparatus of claim 18, further comprising:
a player name database maintaining each player name of at least one sporting event; and
a player name recognition module extracting, from the player name database, a player name having a greatest similarity to the recognized text information.

26. The apparatus of claim 25, wherein the player name recognition module extracts the player name having the greatest similarity to the recognized text information from the player name database by a string matching by a word unit, the string matching by the word unit being performed in a full name matching and a family name matching order.

27. The apparatus of claim 25, wherein the player name recognition module receives predetermined player name information from an external server via a predetermined communication module, stores the player name information in the player name database, and stores the player name information, interpreted from a player name caption included in the sports video, in the player name database.

28. A text recognition module, comprising:
a line unit text generation unit generating a line unit text area by collecting texts connected to each other, from other texts included in the text area, in a single area, about a text area which is detected from a predetermined video caption area; and
a text information recognition unit recognizing predetermined text information by interpreting the line unit text area.

29. The apparatus of claim 28, wherein the line unit text generation unit generates the line unit text area by performing a CCA of the single area where the texts connected to each other are collected.

30. The apparatus of claim 28, wherein the text information recognition unit interprets the line unit text by OCR.

31. The apparatus of claim 28, further comprising:
a similar word correction unit correcting a similar word of the recognized text information.
